(19) United States
(12) Patent Application Publication
(10) Pub. No.: US 2017/0089006 A1
(43) Pub. Date: Mar. 30, 2017

(54) Permanent Treatment Having Reversibly Enhanced Thermal Properties Easily Applied at Home

(71) Applicant: Monte Christopher Magill, Fairborn, OH (US)

(72) Inventor: Monte Christopher Magill, Fairborn, OH (US)

(21) Appl. No.: 15/224,751

(22) Filed: Aug. 1, 2016

Related U.S. Application Data
(60) Provisional application No. 62/203,289, filed on Aug. 10, 2015.

(51) Int. Cl. D06M 23/12; B05D 1/28; B05D 3/02; D06M 10/04; B05D 3/04; B05D 1/02; B05D 5/00

(52) U.S. Cl. CPC D06M 23/12; B05D 1/02; B05D 1/28; B05D 5/00; D06M 10/04; B05D 3/0413; B05D 3/0272; D06M 2200/00

(57) ABSTRACT

Various textiles, garments, apparel and clothing accessories have been available having permanently affixed treatments with reversibly enhanced thermal properties. The creation of which is done in factories where such treatment is applied, on large scale, either topically to such textile substrates or incorporated into fibers. These materials then have the ability to absorb, store and release thermal energy and help buffer temperature swings within the microclimate of clothing or bedding systems keeping the individual more comfortable for an extended period of time. This invention is for an easily applied treatment, in a consumer friendly applicator, which can be cured by methods commonly found in most homes today.

### INVENTION DESCRIPTION

Various textiles, garments, apparel and clothing accessories have been available having permanently affixed treatments with reversibly enhanced thermal properties. The creation of which is done in factories where such treatment is applied, on large scale, either topically to such textile substrates or incorporated into fibers. These materials then have the ability to absorb, store and release thermal energy and help buffer temperature swings within the microclimate of clothing or bedding systems keeping the individual more comfortable for an extended period of time. This invention is for an easily applied treatment, in a consumer friendly applicator, which can be cured by methods commonly found in most homes today.

### BACKGROUND

It is currently possible to have various garments, apparel, clothing accessories, footwear, bedding and even upholstery materials with some method of contained Phase Change Materials (PCMs) for helping to maintain a more comfortable temperature when used in proximity to the user. A PCM is a material that absorbs, stores and releases thermal energy in a narrow temperature range while it changes state, most commonly from solid to liquid, and back, but can be between any phase of matter. There are numerous brands that use such technology, but all such products are currently mass produced and the consumer must buy such products with the PCM treatments already in place. There are also inventions, or products, which allow for polymer or microencapsulated PCMs to garments, but they are applied as non-permanent and are essentially for one time use, at best.

### PROBLEM TO SOLVE

Currently, there is no available method for consumers to apply this PCM technology at home in a “do it yourself” manner such that it will be permanently affixed to whatever product they choose. This invention allows for the consumers to apply such a treatment to the clothing, bedding, upholstery or any other treatable product at home and in such a way that it will be permanently adhered to said product.

### SOLUTION

The solution this invention presents is for a sprayable, whether by pump or propellant, mixture or solution of a PCM system, including a permanently affixable binder system, that the consumer can apply themselves and then cure using methods common to most households. Such methods may include a home dryer, an oven, an iron or other implements capable of heating, without burning, the substrate or product the PCM system is being applied to. In this manner, they can apply as much, or as little, as desired and choose from a variety of temperature ranges of PCM to apply, as would give the best benefits for the application. Furthermore, this invention gives the consumer the ability to re-apply the treatment as often as desired.

### Drawings

# of attached drawings or photographs of the Invention: 0

What is claimed:

What is claimed:

1. A method of permanently treating various garments, apparel, clothing accessories, gloves, footwear, baselayer, bedding, upholstery, rugs, carpeting, carpet backing, seat covers, canvas, foams, insulation or other treatable products with phase change materials, microencapsulated or otherwise, by consumers in the convenience of their own homes.

2. The treatment according to claim 1, may be applied by spray applicator, brush applicator or other method of coating as may be conveniently done by a consumer.

3. The treatment according to claim 1, may be applied to one or more such treated products at the same time.

4. The treatment according to claim 1, may be cured using heating products commonly found in a home such as a blow dryer, hair dryer, clothes dryer, oven, iron or other such heating products capable of drying water, or moisture, from a target item.

5. Said treatment of claim 1 is applied to either side of any of the various receiving products, but most typically to the interior side.

6. The total dry add on weight of said treatment of claim 1, may range from 1 gram per square meter to 1000 grams per square meter but most typically in the range of 20 grams per square meter to 200 grams per square meter.

7. The total dry add on weight, according to claim 6, may be applied via one or more treatments.
